(19) United States
(12) Patent Application Publication
(10) Pub. No.: US 2026/0321499 A1
(43) Pub. Date: Oct. 15, 2026

(54) MULTILAYER ELECTRONIC COMPONENT

(71) Applicant: SAMSUNG ELECTRO-MECHANICS CO., LTD., Suwon-si (KR)

(72) Inventors: Hwa Pyeong YANG, Suwon-si (KR); Young Hoon SONG, Suwon-si (KR); Jin Hyung LIM, Suwon-si (KR); Hyuk Jin HONG, Suwon-si (KR)

(73) Assignee: SAMSUNG ELECTRO-MECHANICS CO., LTD., Suwon-si (KR)

(21) Appl. No.: 19/560,810

(22) Filed: Mar. 9, 2026

(30) Foreign Application Priority Data
Apr. 10, 2025 (KR) 10-2025-0046886

(51) Int. Cl. H01G 4/224; H01G 4/30

(52) U.S. Cl. CPC H01G 4/224; H01G 4/30

(57) ABSTRACT

A multilayer electronic component comprises a stack body including a first dielectric layer and an internal electrode; opposing first and second major surfaces along a first direction, opposing third and fourth surfaces along a second direction, and opposing fifth and sixth surfaces along a third direction; a protection portion including a second dielectric layer disposed on the first, second, fifth, and sixth surfaces; and an external electrode on the stack body and the protection portion, electrically connected to the internal electrode. The protection portion includes a region whose thickness is no more than 90% of a maximum thickness of the protection portion.

### CROSS-REFERENCE TO RELATED APPLICATION(S)

This application claims benefit of priority to Korean Patent Application No. 10-2025-0046886 filed on Apr. 10, 2025, in the Korean Intellectual Property Office, the disclosure of which is incorporated herein by reference in its entirety.

### TECHNICAL FIELD

The present disclosure relates to a multilayer electronic component.

A Multilayer Ceramic Capacitor (MLCC), which is a multilayer electronic component, is a chip‑shaped capacitor mounted on printed circuit boards (PCBs) of various electronic devices, including display devices such as liquid crystal displays (LCD) and plasma display panels (PDP), computers, smartphones, and mobile phones, as well as onboard chargers (OBC) and DC‑DC converters for electric vehicles for charging or discharging electrical energy.

As electronic devices become smaller and more multifunctional, and chip components are miniaturized and more highly integrated, multilayer ceramic electronic components are likewise required to be smaller while providing higher capacitance.

Conventionally, margin portions have been provided either by forming the dielectric layer with an area larger than that of the internal electrodes—thereby leaving a margin region except at regions connected to the external electrodes—or by attaching a separate sheet‑shaped margin layer.

However, when the area of the dielectric layer is formed to be larger than that of the internal electrodes to create a margin region outside the connection to the external electrodes, a difference in the internal‑electrode stacking ratio may cause the internal electrodes to exhibit warpage due to a step difference. In addition, when a margin portion is provided by attaching a separate sheet‑shaped margin layer, mechanical stress can arise at the bonding interface between the margin portion and the capacitance‑formation portion due to differences in shrinkage and expansion rates. Such warpage of the internal electrodes and/or the mechanical stress at the bonding surface between the margin region and the capacitance‑formation portion may cause cracks in a multilayer electronic component and may degrade moisture‑resistance reliability. Thus, there is a need for new and improved warpage of an internal electrode.

### SUMMARY

One of the various aspects of the present disclosure is to alleviate the problem of mechanical stress occurring on a bonding surface between a capacitance formation portion and a margin portion.

One of the various aspects of the present disclosure is to improve a warpage of an internal electrode due to a step portion.

However, the aspects of the present disclosure are not limited to the above-described content, and will be more readily understood in a process of describing specific example embodiments of the present disclosure.

A multilayer electronic component according to an embodiment of the present disclosure may include: a stack body including a first dielectric layer and an internal electrode, and including a first surface and a second surface opposing each other in a first direction, a third surface and a fourth surface connected to the first surface and the second surface and opposing each other in a second direction, and a fifth surface and a sixth surface connected to the first surface to the fourth surface and opposing each other in a third direction; a protection portion disposed on the first surface, the second surface, the fifth surface and the sixth surface and including a second dielectric layer; and an external electrode disposed on the stack body and the protection portion and connected to the internal electrode, and the protection portion may include a region having a thickness of 90% or less of a maximum thickness of the protection portion.

One of the various effects of the present disclosure is to alleviate the problem in which cracks occur in a multilayer electronic component, and improving moisture resistance reliability, by dispersing mechanical stress concentrated on a bonding surface between a capacitance formation portion and a margin portion.

One of the various effects of the present disclosure is to improve BDV characteristics of a multilayer electronic component by mitigating electrode warpage caused by a step portion.

However, advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an example embodiment of the present disclosure;

FIG. 2 schematically illustrates a perspective view of a body in which a stack body and a protection portion are coupled according to an example embodiment;

FIG. 3 is a cross-sectional view taken along line I-I’ of FIG. 1;

FIG. 4 is a cross-sectional view taken along line II-II’ of FIG. 1;

FIG. 5 schematically illustrates a cross-section corresponding to line II-II’ of FIG. 1 in a multilayer electronic component according to a modified embodiment;

FIG. 6 schematically illustrates a cross-section corresponding to line II-II’ of FIG. 1 in a multilayer electronic component according to a modified embodiment;

FIG. 7 schematically illustrates a cross-section corresponding to line II-II’ of FIG. 1 in a multilayer electronic component according to a modified embodiment;

FIG. 8 schematically illustrates a cross-section corresponding to line II-II’ of FIG. 1 in a multilayer electronic component according to a modified embodiment;

FIG. 9 schematically illustrates an operation of stacking a dielectric sheet and an internal electrode pattern according to an example embodiment;

FIG. 10 schematically illustrates an operation of cutting a stacking bar according to an example embodiment;

FIG. 11 schematically illustrates a state in which a cut bar is formed after an operation of cutting a stacking bar according to an example embodiment is performed;

FIG. 12 schematically illustrates an operation of wrapping a dielectric sheet around a cut bar according to an example embodiment; and

FIG. 13 schematically illustrates an operation of cutting a cut bar wrapped around a dielectric sheet to form a unit cut bar.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In addition, in the drawing, an X-direction may mean a thickness direction, a Y-direction may mean a longitudinal direction, and a Z-direction may mean a width direction, and a stacking direction of internal electrodes or dielectric layers may be a thickness direction or a width direction.

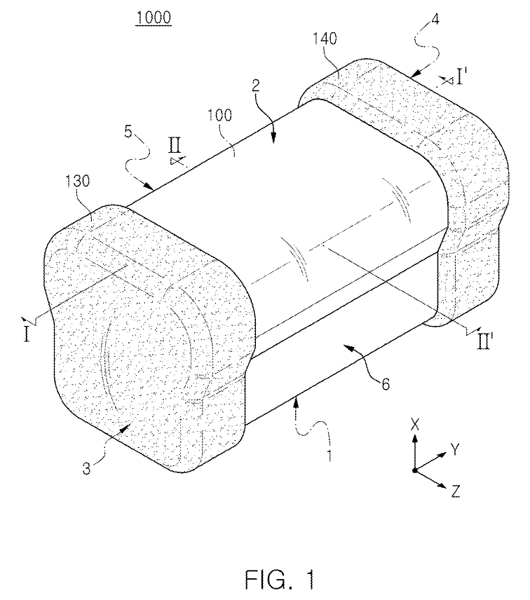

FIG. 1 schematically illustrates a perspective view of a multilayer electronic component according to an example embodiment of the present disclosure.

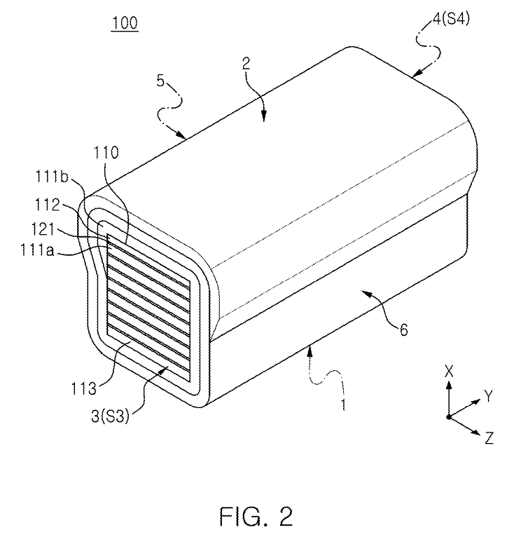

FIG. 2 schematically illustrates a perspective view of a body in which a stack body and a protection portion are coupled according to an example embodiment.

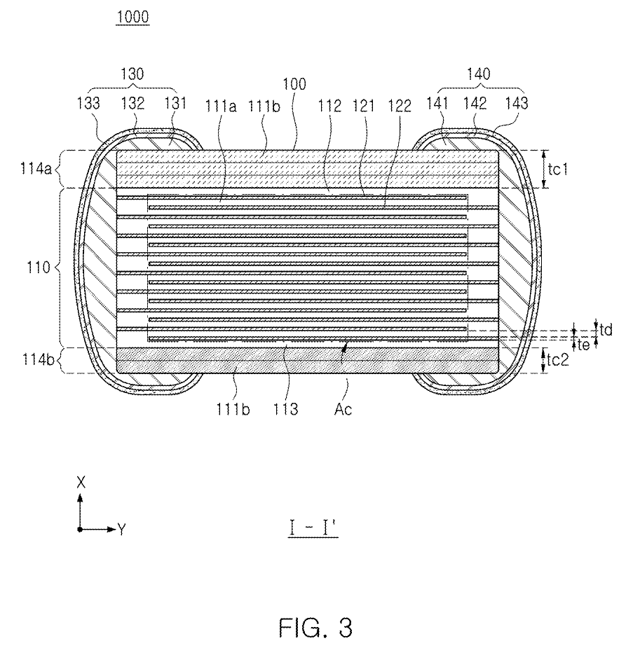

FIG. 3 is a cross-sectional view taken along line I-I’ of FIG. 1.

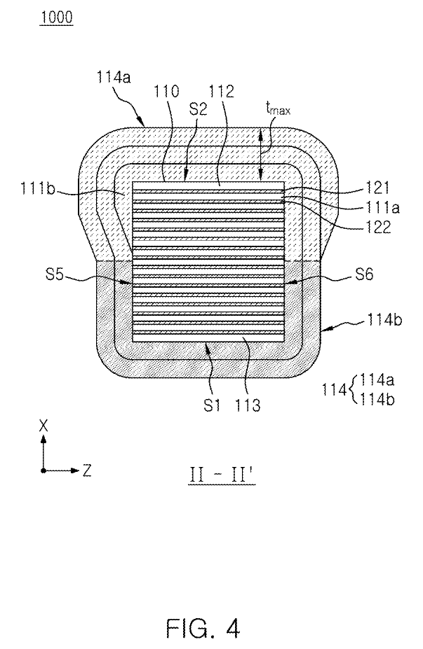

FIG. 4 is a cross-sectional view taken along line II-II’ of FIG. 1.

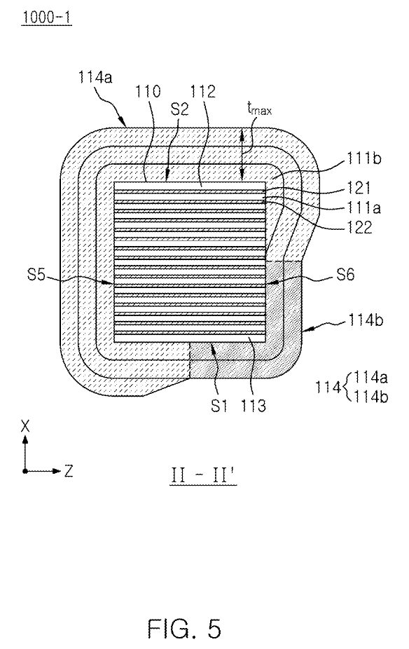

FIG. 5 schematically illustrates a cross-section corresponding to line II-II’ of FIG. 1 in a multilayer electronic component according to a modified embodiment.

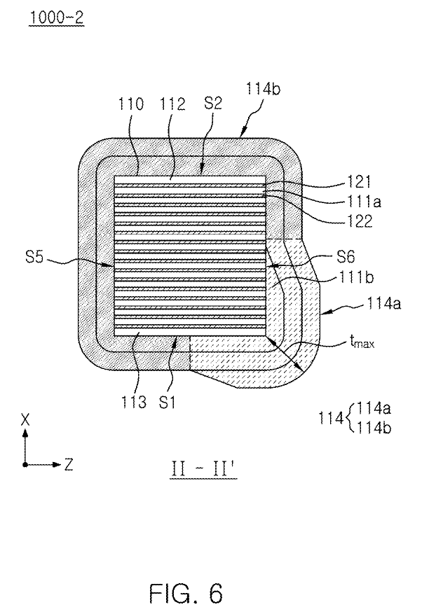

FIG. 6 schematically illustrates a cross-section corresponding to line II-II’ of FIG. 1 in a multilayer electronic component according to a modified embodiment.

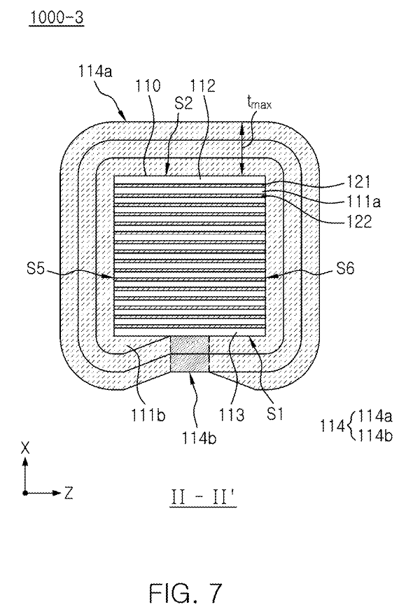

FIG. 7 schematically illustrates a cross-section corresponding to line II-II’ of FIG. 1 in a multilayer electronic component according to a modified embodiment.

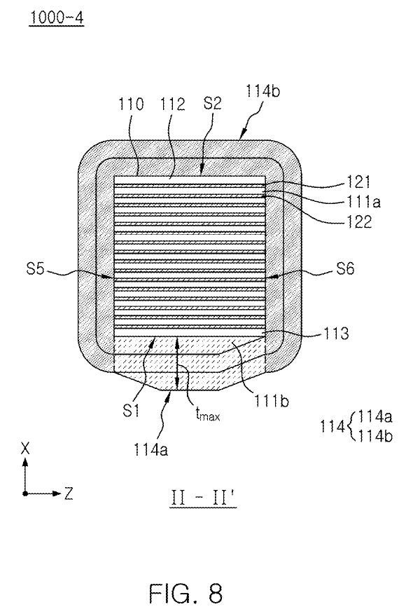

FIG. 8 schematically illustrates a cross-section corresponding to line II-II’ of FIG. 1 in a multilayer electronic component according to a modified embodiment.

Hereinafter, with reference to FIG. 1, FIG. 2, FIG. 3, FIG. 4, FIG. 5, FIG. 6, FIG. 7, and FIG. 8, a multilayer electronic component 1000 according to an example embodiment of the present disclosure, multilayer electronic components 1000-1, 1000-2, 1000-3 and 1000-4 according to modified embodiments thereof, and various example embodiments thereof will be described in detail.

The multilayer electronic component 1000 according to an example embodiment of the present disclosure may include: a stack body 110 including a first dielectric layer 111a and internal electrodes 121 and 122, and including a first surface S1 and a second surface S2 opposing each other in a first direction, a third surface S3 and a fourth surface S4 connected to the first surface S1 and the second surface S2 and opposing each other in the second direction, and a fifth surface S5 and a sixth surface S6 connected to the first through fourth surfaces S1, S2, S3 and S4 and opposing each other in a third direction; a protection portion 114 disposed on the stack body 110 and including a second dielectric layer 111b; and external electrodes 130 and 140 disposed on the stack body 110 and the protection portion 114 and connected to the internal electrodes 121 and 122, and the protection portion 114 may include a region 114b having a thickness of 90% or less of a maximum thickness of the protection portion.

Referring to FIG. 2, a body 100 may include a stack body 110 and a protection portion 114 disposed on the stack body 110, and may include a first side surface 1 and a second side surface 2 opposing in the first direction, a third side surface 3 and a fourth side surface 4 connected to the first side surface 1 and the second side surface 2 and opposing each other in the second direction, and a fifth side surface 5 and a sixth side surface 6 connected to the first to fourth side surfaces 1, 2, 3 and 4 and opposing each other in the third direction.

Referring to FIG. 2, the first dielectric layer 111a and the internal electrodes 121 and 122 may be stacked in the first direction, but the present disclosure is not limited thereto, and the first dielectric layer 111a and the internal electrodes 121 and 122 may also be stacked in the second direction or the third direction.

Referring to FIG. 2 and FIG. 4, the stack body 110 may include the first dielectric layer 111a and the internal electrodes 121 and 122, and referring to FIG. 2, FIG. 3, FIG. 4, FIG. 5, FIG. 6, FIG. 7, and FIG. 8, the stack body 110 may include: a first surface S1 and a second surface S2 opposing each other in the first direction; a third surface S3 and a fourth surface S4 connected to the first surface S1 and the second surface S2 and opposing each other in the second direction; and a fifth surface S5 and a sixth surface S6 connected to the first through fourth surfaces S1, S2, S3 and S4 and opposing each other in the third direction.

The stack body 110 may include a capacitance formation portion Ac, which is a region in which the first dielectric layer 111a and the internal electrodes 121 and 122 overlap each other in the first direction, and cover portions 112 and 113 disposed on one surface and the other surface of the capacitance formation portion Ac in the first direction.

A portion of the stack body 110 may be sintered and may then form a side surface of the body 100, and the protection portion 114 may be disposed on a partial surface of the stack body 110. Specifically, the third surface S3 of the stack body 110 may be a portion of the third side surface 3 of the body 100, the fourth surface S4 of the stack body 110 may be a portion of the fourth side surface 4 of the body 100, and the protection portion 114 may be disposed on the first surface S1, second surface S2, fifth surface S5 and sixth surface S6 of the stack body 110.

The first dielectric layer 111a is in a sintered state, and boundaries between adjacent first dielectric layers 111a may be integrated to be difficult to identify without using a scanning electron microscope (SEM).

A raw material included in the first dielectric layer 111a is not particularly limited, as long as the material obtains sufficient electrostatic capacitance. For example, barium titanate-based materials, lead composite perovskite-based materials, or strontium titanate-based materials may be used.

The first dielectric layer 111a may include a BaTiO₃-based dielectric material. Examples of dielectric materials may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), which is formed by partially employing calcium (Ca) and zirconium (Zr) in BaTiO₃.

Furthermore, the raw material included in the first dielectric layer 111a may be obtained by adding various ceramic additives, organic solvents, binders, dispersants, or the like, to powder particles such as barium titanate (BaTiO₃), depending on the purpose of the present disclosure.

Meanwhile, an average thickness td of the first dielectric layer 111a need not be specifically limited. However, in general, when the first dielectric layer 111a is formed thinly to a thickness of less than 0.6μm, especially when the average thickness td of the first dielectric layer 111a is 0.35μm or less, there may be a concern of reduced reliability.

According to an example embodiment of the present disclosure, since the protection portion 114 is disposed on the first surface S1, the second surface S2, the fifth surface S5 and the sixth surface S6 of the stack body 110, even when an average thickness td of the first dielectric layer 111a is 0.35μm or less, the excellent moisture resistance reliability of the multilayer electronic component 1000 may be ensured.

Accordingly, when the average thickness td of the first dielectric layer 111a is 0.35μm or less, the effects of the present disclosure may be more remarkable, and miniaturization and high capacitance of the multilayer electronic component 1000 may be more easily achieved.

The average thickness td of the first dielectric layer 111a may refer to an average size of the first dielectric layer 111a in the first direction, which is disposed between the first and second internal electrodes 121 and 122. Meanwhile, when the stack body 110 includes a plurality of first dielectric layers 111a, the average thickness td of the first dielectric layer 111a may refer to an average thickness of at least one of the plurality of first dielectric layers 111a.

The average thickness td of the first dielectric layer 111a may be a value obtained by averaging respective thicknesses measured at 1/4, 2/4, and 3/4 points after dividing the dielectric layer into quarters in a longitudinal direction, based on one layer of dielectric layer adjacent to a point at which a longitudinal centerline and a thickness directional centerline of the capacitance formation portion meet, among the dielectric layers extracted from an image obtained by scanning first and second directional cross-sections polished to a center of the body 100 in the third direction, using a scanning electron microscope (SEM). The average thickness of the dielectric layers may be further generalized by expanding such a measurement to the two upper and two lower dielectric layers spaced apart from each other by equal intervals based on one layer of dielectric layer adjacent to a point at which the longitudinal centerline and the thickness directional centerline of the capacitance formation portion meet.

The cover portions 112 and 113 may be disposed on one and the other surfaces of the capacitance formation portion Ac in the first direction.

The cover portions 112 and 113 may be formed by stacking a single dielectric layer or two or more dielectric layers on one surface and the other surface of the capacitance formation portion Ac in the first direction, respectively, and may fundamentally prevent damage to the internal electrodes due to physical or chemical stress.

The cover portions 112 and 113 do not include internal electrodes and may include substantially the same material as the first dielectric layer 111a.

The average thickness of the cover portions 112 and 113 may be substantially the same as the average thickness td of the first dielectric layer 111a, but the present disclosure is not limited thereto.

Here, the average thickness of the cover portions 112 and 113 may refer to an average thickness of each of the first cover portion 112 and the second cover portion 113. The average thickness of the cover portions 112 and 113 may refer to a first directional size, and may be a value obtained by averaging the first directional size of the cover portions 112 and 113 measured at points spaced apart from each other by equal intervals in an upper portion and a lower portion of the capacitance formation portion Ac.

The internal electrodes 121 and 122 may be disposed alternately with the first dielectric layer 111a in the first direction and may include first and second internal electrodes 121 and 122. Referring to FIG. 2, FIG. 3, and FIG. 4, the first and second internal electrodes 121 and 122 may be alternately disposed to face each other with the first dielectric layer 111a interposed therebetween, and may be connected to one or more of the third to sixth surfaces S3, S4, S5 or S6 of the stack body 110.

Specifically, one end of the first internal electrode 121 in the second direction may be connected to the third surface S3, and the other end of the second direction may be spaced from the fourth surface S4, and one end of the second internal electrode 122 in the second direction may be connected to the fourth surface S4, and the other end of the second direction may be spaced from the third surface S3. In this case, the first and second internal electrodes 121 and 122 may be electrically isolated from each other by a dielectric layer 111 disposed therebetween.

Referring to FIG. 4, both ends of the first internal electrode 121 in the third direction and both ends of the second internal electrode 122 in the third direction may be simultaneously connected to the fifth surface S5 and the sixth surface S6. Accordingly, a proportion of the capacitance formation portion Ac in an overall component may be increased to maximize the capacitance per unit volume of the multilayer electronic component 1000. Furthermore, the phenomenon in which the internal electrodes 121 and 122 are warped due to step differences may be mitigated.

A material included in the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), or alloys thereof.

Additionally, the internal electrodes 121 and 122 may be formed by printing a conductive paste for internal electrodes, including one or more of nickel (Ni), copper (Cu), palladium (Pd), silver (Ag), gold (Au), platinum (Pt), tin (Sn), tungsten (W), titanium (Ti), or alloys thereof, onto a ceramic green sheet. The conductive paste for internal electrodes may be printed using screen printing, gravure printing, or the like, and the present disclosure is not limited thereto.

Meanwhile, the average thickness te of the internal electrodes 121 and 122 need not be particularly limited.

However, in general, when the internal electrodes 121 and 122 are formed thinly to less than 0.6μm, especially when the average thickness te of the internal electrodes 121 and 122 is 0.35μm or less, there may be a concern of deterioration in mechanical strength and moisture resistance reliability.

According to an example embodiment of the present disclosure, the protection portion 114 may be disposed on the first surface S1, the second surface S2, the fifth surface S5 and the sixth surface S6 of the stack body 110. Since the protection portion 114 includes a region having a thickness of 90% or less of a maximum thickness (Tmax) of the protection portion 114, even when the average thickness te of the internal electrodes 121 and 122 is 0.35μm or less, the multilayer electronic component 1000 may maintain excellent mechanical strength and moisture resistance reliability.

Accordingly, when the average thickness te of the internal electrodes 121 and 122 is 0.35μm or less, the effects of the present disclosure may be more remarkable, and miniaturization and high capacitance enhancement of the multilayer electronic component 1000 may be more easily achieved.

The average thickness te of the internal electrodes 121 and 122 may refer to an average size of the internal electrodes 121 and 122 in the first direction. Meanwhile, when the body 100 includes a plurality of internal electrodes 121 and 122, the average thickness te of the internal electrodes 121 and 122 may refer to the average thickness of at least one of the pluralities of internal electrodes 121 and 122.

The average thickness te of the internal electrodes 121 and 122 may be a value obtained by averaging respective thicknesses measured at 1/4, 2/4, and 3/4 points after dividing the internal electrode into quarters in a longitudinal direction, based on one layer of internal electrode adjacent to a point at which a longitudinal centerline and a thickness directional centerline of the capacitance formation portion meet, among the internal electrodes extracted from an image obtained by scanning first and second directional cross-sections polished to a center of the body 100 in the third direction, using a scanning electron microscope (SEM). The average thickness of the internal electrodes may be further generalized by expanding such a measurement to the two upper and two lower internal electrodes spaced apart from each other by equal intervals based on one layer of internal electrode adjacent to a point at which the longitudinal centerline and the thickness directional centerline of the capacitance formation portion meet.

Referring to FIG. 1, in the multilayer electronic component 1000 according to an example embodiment, external electrodes 130 and 140 may be disposed on the body 100 including the stack body 110 and the protection portion 114.

Specifically, a first external electrode 130 may be disposed on the third side surface 3 of the body 100 and connected to the first internal electrode 121, and a second external electrode 140 may be disposed on the fourth side surface 4 of the body 100 and connected to the second internal electrode 122.

While this example embodiment describes a multilayer electronic component 1000 having two external electrodes 130 and 140, the number and shape of external electrodes 130 and 140 may vary depending on the shape of the internal electrodes 121 and 122 or other purposes.

Meanwhile, the external electrodes 130 and 140 may be formed using any material that is electrically conductive, such as metal, and the specific material may be determined based on factors such as electrical properties and structural stability, and furthermore, the external electrodes may have a multilayer structure.

Referring to FIG. 3, the external electrodes 130 and 140 may include electrode layers 131 and 141 in contact with the body 100 and plating layers 132, 133, 142 and 143 disposed on the electrode layers 131 and 141.

For more specific examples of the electrode layers 131 and 141, the electrode layers 131 and 141 may be sintered electrodes including a conductive metal and glass, or resin-based electrodes including a conductive metal and a resin.

Additionally, the electrode layers 131 and 141 may be formed by sequentially forming a sintered electrode and a resin-based electrode on the body 100. Furthermore, the electrode layers 131 and 141 may be formed by transferring a sheet including a conductive metal onto the body 100, or by transferring a sheet including a conductive metal onto a sintered electrode.

The conductive metal included in the electrode layers 131 and 141 may be any material having excellent electrical conductivity, and is not particularly limited. For example, the conductive metal may be one or more of nickel (Ni), copper (Cu), or alloys thereof.

The plating layers 132, 133, 142 and 143 may improve the sealing or mounting characteristics of the multilayer electronic component 1000. The type of plating layers 132, 133, 142 and 143 is not particularly limited, and the plating layers 132, 133, 142 and 143 may be plating layers including one or more of Ni, Sn, Pd, or alloys thereof, and may be comprised of a plurality of layers.

More specific examples of the plating layers 132, 133, 142 and 143 may include a Ni plating layer including Ni or a Sn plating layer including Sn, and may have a shape in which a plating layer including Ni and a plating layer including Sn may be sequentially formed on the electrode layers 131 and 141, or may have a shape in which a plating layer including Sn, a plating layer including Ni, and a plating layer including Sn may be sequentially formed. Additionally, the plating layer may include a plurality of Ni plating layers and/or a plurality of Sn plating layers.

The multilayer electronic component 1000 according to an example embodiment of the present disclosure may include the protection portion 114 disposed on the stack body 110 and including the second dielectric layer 111b.

As in an example embodiment of the present disclosure, the protection portion 114, formed on the stack body 110 in which the first dielectric layer 111a and the internal electrodes 121 and 122 are stacked, may serve to enhance mechanical strength and to improve moisture resistance reliability.

In an example embodiment of the present disclosure, the protection portion 114 may be disposed on the first surface S1, the second surface S2, the fifth surface S5 and the sixth surface S6, and may mitigate occurrence of cracking in the multilayer electronic component 1000 by controlling a shape thereof and may improve reliability.

Specifically, the protection portion 114 may include a region 114b having a thickness of 90% or less of the maximum thickness (Tmax) of the protection portion 114, and in an example embodiment, the region 114b having a thickness of 90% or less of the maximum thickness (Tmax) of the protection portion 114 may be a second region, and a region 114a having a thickness exceeding 90% of the maximum thickness (Tmax) of the protection portion 114 may be a first region 114a.

In a conventional case of forming a margin portion by attaching separate sheets to the fifth surface S5 and the sixth surface S6 of the stack body 110, or forming a cover portion by attaching separate sheets to the first surface S1 and second surface S2, due to differences in shrinkage and expansion rates between the margin portion and the stack body 110 or the cover portion and the stack body 110, an interface between the margin portion and the stack body 110 or the cover portion and the stack body 110 may be subjected to mechanical stress in a parallel direction, which may cause cracks due to shrinkage and expansion, and an interface between the margin portion and the stack body 110 or the cover portion and the stack body 110 may act as a path for moisture penetration, resulting in a decrease in the moisture resistance reliability of the multilayer electronic component 1000.

Meanwhile, since the mechanical stress applied to the protection portion 114 according to an example embodiment of the present disclosure is perpendicular to the mechanical stress applied along an outer surface of the stack body 110, the possibility of cracks occurring due to differences in shrinkage and expansion rates between the stack body 110 and the protection portion 114 may be reduced, and the moisture resistance reliability of the multilayer electronic component 1000 may be improved by preventing external moisture penetration.

Meanwhile, the protection portion 114 according to an example embodiment of the present disclosure may have a region including the region 114b having a thickness of 90% or less of the maximum thickness (Tmax) of the protection portion 114, and thus, the protection portion 114 according to an example embodiment may be divided into a first region 114a having a relatively thick thickness and a second region 114b having a relatively thin thickness. In such a structure, the protection portion 114 may have a form in which one dielectric sheet surrounds the stack body 110, thereby further improving the moisture resistance reliability of the multilayer electronic component 1000.

In an example embodiment, the protection portion 114 may be divided into a first region 114a, which has a thickness exceeding 90% of the maximum thickness (Tmax) of the protection portion 114, and a second region 114b, which has a thickness less than 90% of the maximum thickness (Tmax) of the protection portion 114.

In an example embodiment, the first region 114a may have a thickness exceeding 90% of the maximum thickness (Tmax) of the protection portion 114, and may have a thickness less than the maximum thickness (Tmax) of the protection portion 114.

In an example embodiment, the second region 114b may have a thickness of 90% or less of the maximum thickness (Tmax) of the protection portion 114 and may have a thickness of 80% or more of the maximum thickness (Tmax) of the protection portion 114. When the second region 114b has a thickness less than 80% of the maximum thickness (Tmax) of the protection portion 114, the symmetry of the multilayer electronic component 1000 may deteriorate, resulting in a decrease in quality uniformity.

The maximum thickness (Tmax) of the protection portion 114 and the thickness of each region forming the protection portion 114 for each position may be measured by observing the first and third directional cross-sections obtained by polishing the multilayer electronic component 1000 to a center thereof in the second direction, using an optical microscope (OM), a scanning electron microscope (SEM), a transmission electron microscope (TEM), or the like, and using an image analysis program. In an example embodiment, the thickness of the protection portion 114 may refer to the vertical distance from the first surface S1, the second surface S2, the fifth surface S5 and the sixth surface S6 to an outer surface of the protection portion 114, and the maximum thickness of the protection portion 114 may refer to a maximum value of the vertical distance from the first surface S1, the second surface S2, the fifth surface S5 and the sixth surface S6 to the outer surface of the protection portion 114.

In an example embodiment, the first region 114a may include a point at which the maximum thickness (Tmax) of the protection portion 114 is formed, and may include a region at which the thickness gradually decreases from the point at which the maximum thickness (Tmax) is formed, toward the second region 114b. In other words, the thicknesses of the first region 114a and the second region 114b may be changed continuously within the first region.

In an example embodiment, an average thickness tc2 of the second region 114b may be less than an average thickness tc1 of the first region 114a. More specifically, the average thickness tc2 of the second region 114b may be 90% or less of the average thickness tc1 of the first region 114a.

The average thickness tc1 of the first region 114a and the average thickness tc2 of the second region 114b may be measured, using an image analysis program, by observing the first and third directional cross-sections obtained by polishing the multilayer electronic component 1000 to the center in the second direction, or first and second directional cross-sections obtained by polishing the multilayer electronic component 1000 to the center in the third direction, using an optical microscope (OM), a scanning electron microscope (SEM), a transmission electron microscope (TEM), or the like. Meanwhile, based on FIG. 3, the average thickness tc1 of the first region 114a and the average thickness tc2 of the second region 114b may be a value obtained by averaging the first directional sizes measured at two or more points equally spaced apart from each other to the left in the second direction and at two or more points equally spaced apart from each other to the right in the second direction, based on the second directional center.

In an example embodiment, the protection portion 114 may be disposed to surround the first surface S1, the second surface S2, the fifth surface S5 and the sixth surface S6. Accordingly, the first surface S1, the second surface S2, the fifth surface S5 and the sixth surface S6 of the stack body 110 may not be exposed to the outside, and even when the cover portions 112 and 113 are thin, the moisture resistance reliability of the multilayer electronic component 1000 may be secured.

According to an example embodiment, a corner of the protection portion 114 may have a round shape. Accordingly, the stress that may be concentrated on the corners of the multilayer electronic component 1000 may be dispersed, thereby reducing the risk of occurrence of cracking in the multilayer electronic component 1000. The rounded corners of the protection portion 114 may be formed naturally when the dielectric layer 111b surrounding the stack body 110 is wrapped around the stack body 110, but the present disclosure is not limited thereto, and a method of forming the protection portion 114 by separately polishing the surface of the body 100 may also be used.

In an example embodiment, the protection portion 114 may cover third directional ends of the internal electrodes 121 and 122. Accordingly, the internal electrodes 121 and 122 may not be exposed to the outside, and short circuits between the internal electrodes 121 and 122 and the external electrodes 130 and 140 may be prevented.

The second dielectric layer 111b may be in a sintered state and may include a BaTiO₃-based dielectric material. Examples of dielectric materials may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), which is formed by partially employing calcium (Ca) and zirconium (Zr) in BaTiO₃.

Meanwhile, the first dielectric layer 111a is a dielectric layer included in the stack body 110 and may primarily serve to secure electrostatic capacitance, and the second dielectric layer 111b is a dielectric layer formed on the stack body 110 and may primarily serve to improve electrical insulation and mechanical strength. Accordingly, the first dielectric layer 111a and the second dielectric layer 111b may have different types or contents of auxiliary elements or doping elements, excluding the BaTiO₃-based material, and may have different microstructures.

In an example embodiment, when an average dielectric grain size of the first dielectric layer 111a is defined as G1 and an average dielectric grain size of the second dielectric layer 111b is G2, G1 > G2 may be satisfied. Accordingly, the permittivity of the first dielectric layer 111a included in the stack body 110, which directly contributes to the formation of electrostatic capacitance, may be improved, and the mechanical strength of the second dielectric layer 111b included in the protection portion 114, which plays a greater role in ensuring moisture resistance reliability and mechanical strength, may be improved.

The average dielectric grain size of the first dielectric layer 111a and the average dielectric grain size of the second dielectric layer 111b may be measured by observing the first and third directional cross-sections obtained by polishing the multilayer electronic component 1000 to the second directional center thereof using a scanning electron microscope (SEM), transmission electron microscope (TEM), or the like, at a magnification of 50,000X or greater, and calculating a grain area using an image analysis program, and then converting the grain area to an equivalent diameter of a circle. A measurement region for the average dielectric grain size of the first dielectric layer 111a may be a region having an area of at least 1μm × 1μm of two or more points equally spaced from each other to the left in the third direction and two or more points equally spaced from each other to the right in the third direction, based on third direction center of the first dielectric layer 111a. When such a measurement region is expanded to two or more dielectric layers equally spaced apart from each other upward in the first direction and two or more first dielectric layers equally spaced apart from each other downward in the first direction, based on the first dielectric layer closest to the first directional center and the third directional direction thereof, an average dielectric grain size of the first dielectric layer 111a may be further generalized. The average dielectric grain size of the second dielectric layer 111a may be measured in a region having an area of at least 1μm × 1μm of two or more points equally spaced apart from each other vertically in the first direction and two or more points equally spaced apart from each other horizontally in the third direction, based on a first directional center or a third directional center of the protection portion 114.

Referring to FIG. 4, FIG. 5, FIG. 6, FIG. 7, and FIG. 8, the first region 114a and the second region 114b may be disposed variously depending on the purpose.

Referring to FIG. 4, in the multilayer electronic component 1000 according to an example embodiment, the first region 114a may be disposed on three surfaces of the first surface S1, the second surface S2, the fifth surface S5 and the sixth surface S6, and the second region 114b may be disposed on three surfaces of the first surface S1, the second surface S2, the fifth surface S5 and the sixth surface S6.

Referring to FIG. 5, in a multilayer electronic component 1000-1 according to a modified embodiment, the first region 114a may be disposed on four surfaces of the first surface S1, the second surface S2, the fifth surface S5 and the sixth surface S6, and the second region 114b may be disposed on two surfaces of the first surface S1, the second surface S2, the fifth surface S5 and the sixth surface S6.

Referring to FIG. 6, in a multilayer electronic component 1000-2 according to a modified embodiment, the first region 114a may be disposed on two surfaces of the first surface S1, the second surface S2, the fifth surface S5 and the sixth surface S6, and the second region 114b may be disposed on four surfaces of the first surface S1, the second surface S2, the fifth surface S5 and the sixth surface S6.

Referring to FIG. 7, in a multilayer electronic component 1000-3 according to a modified embodiment, the first region 114a may be disposed on four surfaces of the first surface S1, the second surface S2, the fifth surface S5 and the sixth surface S6, and the second region 114b may be disposed on one surface of the first surface S1, the second surface S2, the fifth surface S5 and the sixth surface S6.

As in an example embodiment of the present disclosure, when the protection portion 114 includes a region having a thickness of 90% or less of the maximum thickness (Tmax) of the protection portion 114, the mechanical strength and moisture resistance reliability of the multilayer electronic component may be improved, but quality unevenness may occur due to an asymmetrical shape thereof.

On the other hand, in the case of the multilayer electronic component 1000-3 according to the modified embodiment, the first region 114a may be disposed on four surfaces of the first surface S1, the second surface S2, the fifth surface S5 and the sixth surface S6, and the second region 114b may be disposed on one surface of the first surface S1, the second surface S2, the fifth surface S5 and the sixth surface S6. Accordingly, it may be possible to minimize the proportion of the second region 114b, which has a thickness of 90% or less of the maximum thickness of the protection, to the entire protection portion 114, thereby alleviating quality unevenness in the multilayer electronic component 1000.

Referring to FIG. 8, in a multilayer electronic component 1000-4 according to a modified embodiment, the first region 114a may be disposed on one surface of the first surface S1, the second surface S2, the fifth surface S5 and the sixth surface S6, and the second region 114b may be disposed on three surfaces of the first surface S1, the second surface S2, the fifth surface S5 and the sixth surface S6.

As in an example embodiment of the present disclosure, when the protection portion 114 includes a region having a thickness of 90% or less of the maximum thickness (Tmax) of the protection portion 114, the mechanical strength and moisture resistance reliability of the multilayer electronic component may be improved, but quality unevenness may occur due to an asymmetrical shape thereof.

On the other hand, in the multilayer electronic component 1000-4 according to a modified embodiment, the first region 114a may be disposed on one surface of the first surface S1, the second surface S2, the fifth surface S5 and the sixth surface S6, and the second region 114b may be disposed on three surfaces of the first surface S1, the second surface S2, the fifth surface S5 and the sixth surface S6. Accordingly, it may be possible to minimize the proportion of the first region 114a, which has a thickness exceeding 90% of the maximum thickness of the protection portion, to the entire protection portion 114, thereby alleviating quality unevenness in the multilayer electronic component 1000.

An arrangement region of the first region 114a and the second region 114b depicted in FIG. 4, FIG. 5, FIG. 6, FIG. 7, and FIG. 8 may be adjusted by changing starting and ending positions of a dielectric sheet surrounding the stack body 110, but the present disclosure is not limited thereto.

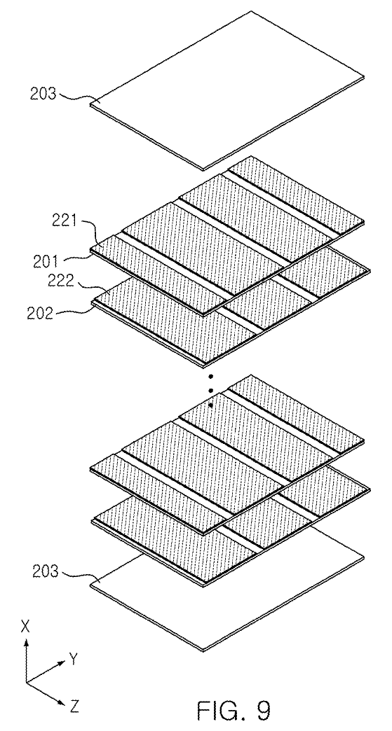

FIG. 9 schematically illustrates an operation of stacking a dielectric sheet and an internal electrode pattern according to an example embodiment.

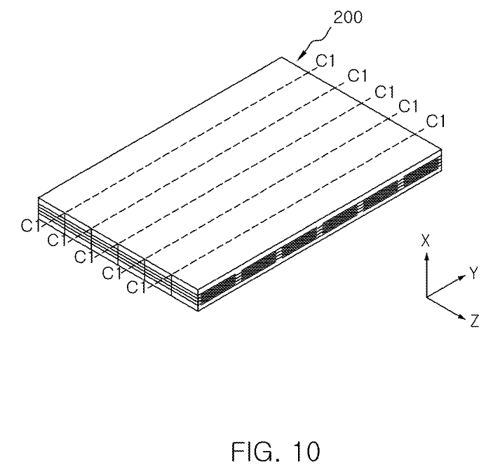

FIG. 10 schematically illustrates an operation of cutting a stacking bar according to an example embodiment.

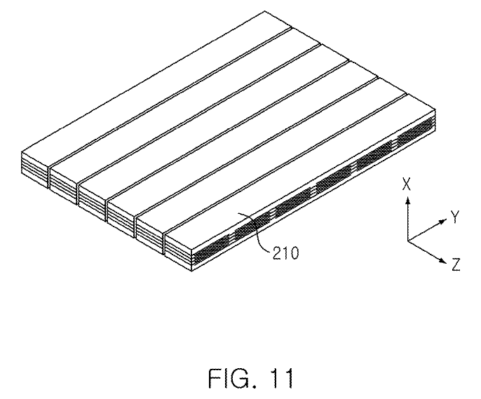

FIG. 11 schematically illustrates a state in which a cut bar is formed after an operation of cutting a stacking bar according to an example embodiment is performed.

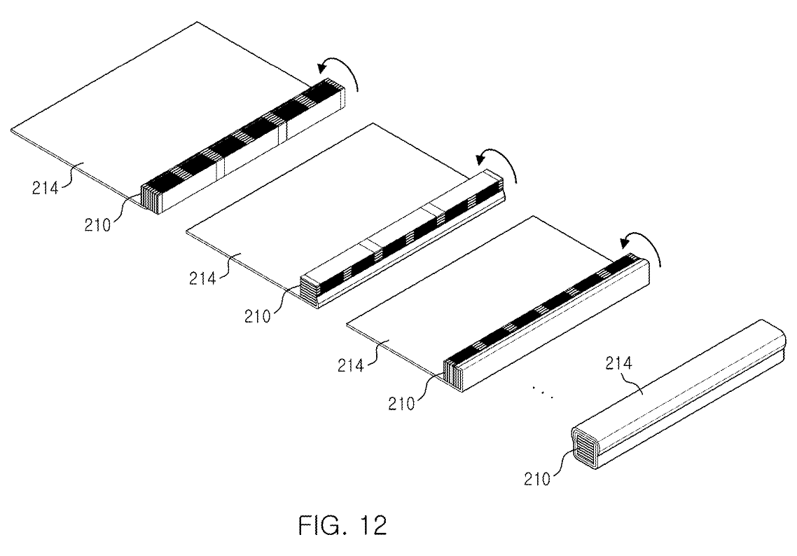

FIG. 12 schematically illustrates an operation of wrapping a dielectric sheet around a cut bar according to an example embodiment.

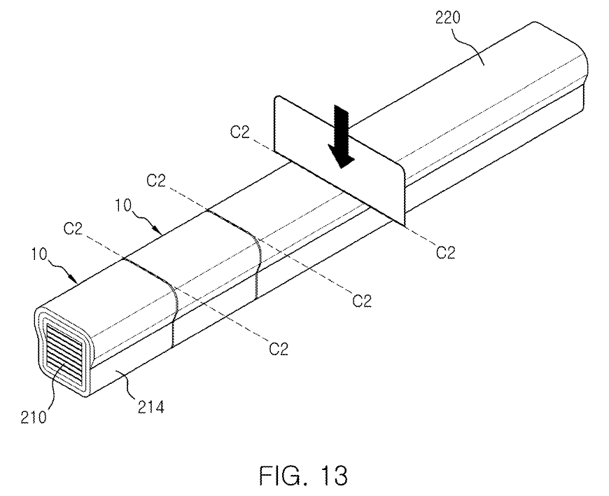

FIG. 13 schematically illustrates an operation of cutting a cut bar wrapped around a dielectric sheet to form a unit cut bar.

Hereinafter, with reference to FIG. 9, FIG. 10, FIG. 11, FIG. 12, and FIG. 13, an example of a method of manufacturing a multilayer electronic component 1000 according to an example embodiment of the present disclosure will be described in detail. However, the method of manufacturing the multilayer electronic component 1000 described below is not limited to the multilayer electronic component 1000 according to an example embodiment of the present disclosure, an example embodiment thereof, and a modified embodiment thereof.

Referring to FIG. 9, internal electrode patterns 221 and 222 may be formed on dielectric sheets 201 and 202, and the internal electrode patterns 221 and 222 disposed on the dielectric sheets 201 and 202 may be repeatedly stacked. A cover sheet 203 may be disposed on a plurality of stacked dielectric sheets 201 and 202 and the internal electrode patterns 221 and 222.

The dielectric sheets 201 and 202 may be formed of a ceramic paste including ceramic powder particles, an organic solvent, a dispersant, and a binder. The ceramic powder particles is a raw material for forming the first dielectric layer 111a of the multilayer electronic component 1000, and may use a barium titanate-based material, a lead composite perovskite-based material, or a strontium titanate-based material.

The cover sheet 203 may be formed of the same material as the dielectric sheets 201 and 202, and may be comprised of the same materials and components, but the present disclosure is not limited thereto, and the upper and lower cover portions 112 and 113 of the body 100 may be formed through a sintering process.

The components of the internal electrode patterns 221 and 222 may be formed on the dielectric sheets 201 and 202 using an internal electrode paste including a conductive metal. The conductive metal included in the conductive patterns 221 and 222 is not particularly limited, and any material having excellent electrical conductivity may be used. For example, the conductive metal may include one or more of nickel (Ni), copper (Cu), palladium (Pd), silver (Ag), gold (Au), platinum (Pt), tin (Sn), tungsten (W), titanium (Ti), or alloys thereof. The internal electrode patterns 221 and 222 may be formed by screen-printing or gravure-printing conductive paste onto the dielectric sheets 201 and 202.

The internal electrode patterns 221 and 222 may be formed in the form of stripes in which a plurality of conductive patterns are spaced apart from each other by substantially equal intervals. The spaced intervals of a first internal electrode pattern 221 and the spaced patterns of the second internal electrode pattern 222 may be disposed so as to be offset from each other when viewed in the stacking direction.

Referring to FIG. 10 and FIG. 11, the plurality of stacked dielectric sheets 201 and 202, the internal electrode patterns 221 and 222, and the cover sheet 203 may be compressed together to form a stacking bar 200. After forming the stacking bar 200, the stacking bar 200 may be cut along line C1-C1 to form a cut bar 210. The method of cutting the stacking bar 200 is not particularly limited, and for example, the stack body 200 may be cut using a blade cutting method such as a doctor blade or dicing blade, a guillotine cutting method, or a laser cutting method.

Referring to FIG. 12, after forming the cut bar 210, an operation of forming a protection sheet 214 on a surface of the cut bar 210 and forming a cut bar-protection sheet composite 220 may be performed.

The protection sheet 214 may be a single dielectric sheet, and thus, the protection portion 114 of the multilayer electronic component 1000 according to an example embodiment may be integrally formed on the first surface S1, the second surface S2, the fifth surface S5, and the sixth surface S6 of the stack body 110.

Meanwhile, the protection sheet 214 need not necessarily be a single dielectric sheet, and the protection sheet 214 may have a form in which a plurality of dielectric sheets are stacked.

The protection sheet 214 may differ from the dielectric sheets 201 and 202 in one or more of a composition and/or a microstructure. Specifically, the types and contents of auxiliary elements or doping elements, excluding the BaTiO₃-based material, may differ, and the dielectric powder particles included in each sheet may differ in size.

The protection sheet 214 may be wound around the cut bar 210 as a central axis. A process of winding the protection sheet 214 around the cut bar 210 as a central axis may continue even after a surface of the cut bar 210 is completely covered by the protection sheet 214. Accordingly, the protection portion 114 of the multilayer electronic component 1000 according to an example embodiment may include a first region 114a having a thickness exceeding 90% of the maximum thickness (Tmax) and a second region 114b having a thickness of 90% or less of the maximum thickness (Tmax).

A thickness difference between the first region 114a and the second region 114b of the multilayer electronic component 1000 according to an example embodiment may be adjusted depending on a thickness of the protection sheet 214. Specifically, as the thickness of the protection sheet 214 increases, a thickness difference between the first region 114a and the second region 114b may increase. Meanwhile, formation positions of the first region 114a and the second region 114b of the multilayer electronic component 1000 according to an example embodiment may be adjusted depending on the positions of winding start and end points of the protection sheet 214.

After forming the cut bar-protection sheet composite 220, an operation of cutting the cut bar-protection sheet composite 220 and forming an unsintered body 10 may be performed, and the operation of forming the unsintered body 10 may be performed by cutting the cut bar-protection sheet composite 220 along line C2-C2, and a method of cutting the cut bar-protection sheet composite 220 is not particularly limited. For example, the cut bar-protection sheet composite 220 may be cut using a blade cutting method such as a doctor blade or dicing blade, a guillotine cutting method, or a laser cutting method.

After the operation of forming the unsintered body 10, an operation of sintering the unsintered body 10 and forming the body 100 may be performed. A sintering temperature is not particularly limited, but may be, for example, 1000 to 1300° C. Furthermore, firing may be performed in a reducing atmosphere.

Accordingly, the external electrodes 130 and 140 may be formed on the third and fourth surfaces 3 and 4 of the body 100, respectively, to manufacture the multilayer electronic component 100.

Meanwhile, a sintering operation of the unsintered body 10 may be performed before forming the external electrodes 130 and 140, but the present disclosure is not limited thereto, and a conductive paste including a metal having excellent electrical conductivity may be formed on each of exposed surfaces of the internal electrode patterns of the unsintered body 10 and may be sintered simultaneously with the body 100, thereby manufacturing the multilayer electronic component 1000.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression an example embodiment' used in the present disclosure does not mean the same embodiment, and is provided to emphasize and explain different unique characteristics. However, the example embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a stack body including a first dielectric layer and an internal electrode, and including a first surface and a second surface opposing each other in a first direction, a third surface and a fourth surface connected to the first surface and the second surface and opposing each other in a second direction, and a fifth surface and a sixth surface connected to the first surface to the fourth surface and opposing each other in a third direction;
a protection portion disposed on the first surface, the second surface, the fifth surface and the sixth surface and including a second dielectric layer; and
an external electrode disposed on the stack body and the protection portion and connected to the internal electrode,
wherein the protection portion includes a region having a thickness of 90% or less of a maximum thickness of the protection portion.

2. The multilayer electronic component according to claim 1, wherein the protection portion includes a first region which is a region having a thickness exceeding 90% of the maximum thickness of the protection portion, and a second region having a thickness of 90% or less of the maximum thickness of the protection portion.

3. The multilayer electronic component according to claim 2, wherein the first region is disposed on three surfaces of the first surface, the second surface, the fifth surface and the sixth surface, and the second region is disposed on three surfaces of the first surface, the second surface, the fifth surface and the sixth surface.

4. The multilayer electronic component according to claim 2, wherein the first region is disposed on four surfaces of the first surface, the second surface, the fifth surface and the sixth surface, and the second region is disposed on two surfaces of the first surface, the second surface, the fifth surface and the sixth surface.

5. The multilayer electronic component according to claim 2, wherein the first region is disposed on two surfaces of the first surface, the second surface, the fifth surface and the sixth surface, and the second region is disposed on four surfaces of the first surface, the second surface, the fifth surface and the sixth surface.

6. The multilayer electronic component according to claim 2, wherein the first region is disposed on four surfaces of the first surface, the second surface, the fifth surface and the sixth surface, and the second region is disposed on one surface of the first surface, the second surface, the fifth surface and the sixth surface.

7. The multilayer electronic component according to claim 2, wherein the first region is disposed on one surface of the first surface, the second surface, the fifth surface and the sixth surface, and the second region is disposed on three surfaces of the first surface, the second surface, the fifth surface and the sixth surface.

8. The multilayer electronic component according to claim 1, wherein the protection portion is disposed to surround the first surface, the second surface, the fifth surface and the sixth surface.

9. The multilayer electronic component according to claim 1, wherein the protection portion covers a third directional end of the internal electrode.

10. The multilayer electronic component according to claim 1, wherein a corner of the protection portion has a round shape.

11. The multilayer electronic component according to claim 1, wherein the second dielectric layer is provided in plural.

12. The multilayer electronic component according to claim 2, wherein the second region has a thickness of 80% or more of the maximum thickness of the protection portion.

13. The multilayer electronic component according to claim 1, wherein when an average dielectric grain size of the first dielectric layer is defined as G1 and an average dielectric grain size of the second dielectric layer is defined as G2, G1 > G2 is satisfied.

14. The multilayer electronic component according to claim 1, wherein a thickness of the protection portion is a vertical distance from the first surface, the second surface, the fifth surface and the sixth surface to an outer surface of the protection portion.

15. The multilayer electronic component of claim 1, wherein the protection portion is integrally formed from a single dielectric sheet that surrounds the first, second, fifth, and sixth surfaces.

16. The multilayer electronic component of claim 1, wherein an average thickness (tc2) of the second region is 90% or less of an average thickness (tc1) of the first region.
